(19) United States
(12) Patent Application Publication
(10) Pub. No.: US 2025/0109772 A1
(43) Pub. Date: Apr. 3, 2025

(54) FRICTION ASSEMBLY FOR A BRAKE SYSTEM FOR RAILWAY ROLLING STOCK

(71) Applicant: TALLANO TECHNOLOGIES, Paris (FR)

(72) Inventors: Loïc ADAMCZAK, Paris (FR); Adrien MAISTRE, Paris (FR)

(73) Assignee: TALLANO TECHNOLOGIES, Paris (FR)

(21) Appl. No.: 18/726,993

(22) PCT Filed: Jan. 9, 2023
(86) PCT No.: PCT/FR2023/050023

§ 371 Date: Jul. 5, 2024

(30) Foreign Application Priority Data
Jan. 14, 2022 (FR) 2200321

(51) Int. Cl. F16D 65/00; F16D 65/092; F16D 69/00

(52) U.S. Cl. CPC F16D 65/0031; F16D 65/092; F16D 2069/004

(57) ABSTRACT

A friction assembly for brakes includes a brake head with lower and upper faces and a secondary duct connecting the two faces, and a brake shoe with first and second faces and a primary duct connecting the two faces. The brake shoe has a plate with a base which forms part of the second face for fixing to the lower face. The friction assembly includes a connecting ring arranged in the secondary duct and which establishes a connection with the primary duct, and a return mechanism which holds the connecting ring in contact with the second face at a circumferential contact zone. The connecting ring comes into contact solely with the base.

This invention relates to the braking of railway rolling stock and in particular the friction assemblies of the braking systems of railway rolling stock. Such equipment is understood to mean all vehicles configured to run on rails, such as trains, trams, and underground trains.

The braking system generally includes a disc secured to a wheel or axle of the railway rolling stock. The braking system further includes a friction assembly that comprises a brake head supporting a brake shoe. The brake shoe usually comprises means of attachment to the brake head and a friction pad. When a driver activates the braking system, the friction pad of the brake shoe comes into contact with the disc to exert a braking force on the disc. Thus, by friction, the brake shoe slows down the disc secured to the wheel or axle. Generally, railway rolling stock has two friction assemblies, arranged one on either side of the disc to catch the disc in a pincer grip, or in other words sandwich it in order to compress it on both sides. The friction pad of the brake shoe usually comprises a metal material, such as cast iron, a sintered material, or a composite material. Thus, when the friction pad of the brake shoe rubs against the disc, particles of material from the friction pad and the disc are emitted into the ambient atmosphere around the friction assembly. The braking system thus emits atmospheric pollution in the form of particles that are more or less fine.

There have therefore been attempts to capture the particles of materials emitted during braking, in particular by placing a suction device, powered by a pump, near an area of particle emission from the friction pad of the brake shoe. In addition, there have been attempts to ensure that this particle suction is as effective as possible.

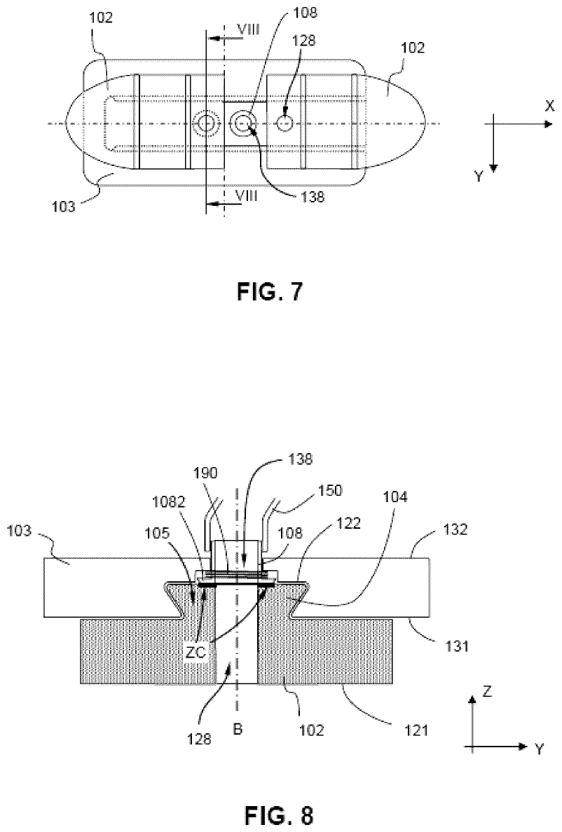

One solution to this problem is the friction assembly illustrated in FIGS. 7 and 8, which represent the prior art. This prior art is described in document FR 3088394. FIG. 7 is a bottom view of this assembly, and FIG. 8 is a cross-section along line VIII-VIII of FIG. 7.

Brake head 103 extends longitudinally in a longitudinal direction X, and transversely in a transverse direction Y. The X-Y plane is horizontal. The Z direction, perpendicular to the X-Y plane to form a frame of reference (X,Y,Z), is vertical, oriented upwards. Brake head 103 comprises a lower face 131 intended to accommodate a brake shoe 102, and an upper face 132, each extending parallel to the X-Y plane.

Brake head 103 has, on its lower face 131, a concave dovetail-shaped receiving slide 105, which extends longitudinally from a first end of brake head 103 to close to the second end of brake head 103 where this slide does not reach the end. Brake head 103 comprises, on the longitudinal axis X, two secondary ducts 138 spaced apart from each other. Each secondary duct 138 connects upper face 132 to the bottom of slide 105 on the upper face.

Brake shoe 102 is in two identical parts, each part having a friction face (first face) 121 intended to be in frictional contact with the disc (not shown) of the vehicle and an opposite face (second face) 122. Opposite face 122 has a convex dovetail profile 104 configured to engage with receiving slide 105. During use, a first part of shoe 102 is pushed in along the longitudinal axis by sliding profile 104 in slide 105, until it abuts against slide 105. Then the second part of shoe 102 is inserted along the longitudinal axis X by sliding profile 104 in slide 105, until it abuts against the first part of shoe 102, the contact surfaces of the first part and second part ideally being shaped to fit closely together along their entire surface. Shoe 102 is thus secured to brake head 103.

Each of the parts of shoe 102 comprises a primary duct 128 oriented along the vertical axis Z. When these parts are fixed on brake head 103 during use, each of the two primary ducts 128 is located facing a secondary duct 138. Axis B denotes the main axis of a primary duct 128 and of secondary duct 138 located facing it, primary duct 128 and secondary duct 138 therefore being coaxial. Each primary duct 128 thus forms, with one of secondary ducts 138 provided in brake head 103, a circuit which makes it possible to suction up particles emitted by brake shoe 102 during braking. Axis B is therefore parallel to the vertical axis Z.

A connecting ring 108, consisting of a tube 1081 and a flange 1082 extending this tube radially outwards at one of its ends, is mounted in secondary duct 138. The tube is inserted into secondary duct 138, the outside diameter of the tube being equal to the inside diameter of secondary duct 138 in order to ensure the best possible seal. Flange 1082 is housed in an annular housing of brake head 103, this housing being centered on the main axis B and facing the opposite face 122 of shoe 102. The annular housing has a diameter greater than that of secondary duct 138 and less than that of flange 1082. Thus, flange 1082 is sandwiched between profile 104 of shoe 102 and the bottom of slide 105 of brake head 103. Once in its housing, flange 1082 is in contact with face 122 of profile 104 of shoe 102. Advantageously, this contact is reinforced for example by deformation (crushing) of flange 1082 between the bottom of the housing and face 122. Alternatively (as shown in FIG. 8), this contact is made by compression of a wave spring mounted on the tube between flange 1082 and the bottom of the housing. Thus, flange 1082 itself, or the wave spring, is a return mechanism 190 which allows flange 1082 to be pressed against profile 104 (see below).

Connecting ring 108 completely traverses brake head 103 to its lower face 131 provided with slide 105, and protrudes from its upper face 132. A pipe 150 is fixed to the protruding end of the tube of ring 108, which is connected to a suction device (not shown) and which allows suctioning, through primary duct 128 and secondary duct 138, the particles resulting from braking the railway vehicle due to wear on shoe 102. Pipe 150 and the suction device constitute a particle aspiration device.

Connecting ring 108 serves to guide the particles resulting from braking, from primary duct 128 of shoe 102 to secondary duct 138 of brake head 103. Connecting ring 108 therefore aims to prevent possible leaks through primary duct 128 and secondary duct 138. In particular, connecting ring 108 aims to limit the amount of particles from braking which could slip into the gap at the interface between brake shoe 102 and brake head 103, and above all to prevent a stream of outside air from entering secondary duct 138 through this gap, which would degrade the suction by the suction device.

In addition, connecting ring 108 is pressed against profile 104 by means of a return mechanism 190, as indicated above. Return mechanism 190 contributes to preventing the passage of air at the interface between shoe 102 and brake head 103 at primary duct 128 and secondary duct 138, this passage of air being due to clearances at the interface between brake head 103 and shoe 102.

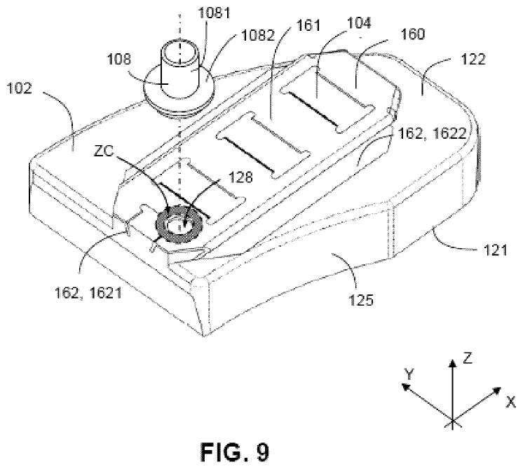

Shoe 102 comprises a friction material 125, and a plate 160 which has a base 161 and tabs 162 extending from base 161. This plate is made of metal, for example. Base 161 forms part of opposite face 122 and of profile 104. Tabs 162 are curved towards friction face 121. Tabs 162 thus comprise first tabs 1621 which penetrate friction material 125 so as to fix friction material 125 to plate 160. Tabs 162 comprise second tabs 1622 which fit against the convex form of profile 104 so as to mechanically hold friction material 125 against base 161. FIG. 9 illustrates a perspective view of shoe 102 with plate 160.

When shoe 102 is secured to brake head 103 by sliding profile 104 in slide 105, flange 1082 of each ring 108 is pressed against second face 122 of profile 104. Flange 1082 thus comes into contact with plate 160 and with friction material 125 at a contact zone ZC which is circumferential so as to surround secondary duct 138.

One thus has a friction assembly for a brake system for railway rolling stock, this friction assembly comprising on the one hand a brake head comprising a lower face, an upper face, and at least one secondary duct of central axis A which connects the lower face and an upper face, on the other hand at least one shoe which has a first face which is the friction face and a second face which is adapted to be fixed on the lower face by a fastening mechanism, and at least one primary duct which connects the first face and the second face, the shoe comprising a friction material and a plate which has a base which forms part of the second face, and the friction assembly further comprising at least one connecting ring which is arranged in the at least one secondary duct and which establishes a connection with the at least one primary duct when the at least one primary duct is aligned with the at least one secondary duct, and also a return mechanism which keeps the at least one connecting ring in contact with the second face at a circumferential contact zone.

Contact zone ZC between ring 108 and second face 122 extends over plate 160 and over friction material 125. However, friction material 125 has a naturally high roughness (visible to the naked eye). In addition, by necessity there is a lack of material at the interface between plate 160 and friction material 125, at the location where tabs 162 penetrate friction material 125. Thus, the contact between ring 108 and second face 122 at contact zone ZC is not perfect and there are leaks in this zone.

One solution to reduce these leaks is to place a coating on the contact zone. This solution complicates the production of the friction assembly.

### DESCRIPTION OF THE INVENTION

The present invention aims to remedy this disadvantage.

The invention aims to propose a friction assembly in which the seal at the contact zone between the ring and the second face is improved.

This goal is achieved due to the fact that the plate is shaped so that each of the connecting rings comes into contact only with the base of the plate and fits closely against the surface of the base at the contact zone.

Thus, the contact zone of the second face consists solely of the base of the plate. The surface of the plate being naturally smooth, each of the connecting rings fits against the surface of the base at the contact zone. By means of these arrangements, leaks between ring 108 and second face 122 at contact zone ZC are minimized.

For example, the surface of the base has undergone surface treatment at the contact zone such that this surface fits more closely against the surface of the at least one ring at the contact zone.

Thus, the surface of the ring fits more closely against the surface of the base of the plate than if the surface of the plate did not undergo surface treatment.

For example, the plate has at least one cylinder which extends from the base along the wall of the at least one primary duct.

The fastening of the plate to the friction material is thus reinforced. In fact, this cylinder acts as a tab, i.e. as an additional anchoring of the plate to the friction material.

For example, the friction assembly further comprises a manifold block which is connected to a suction device and which is secured to the brake head at the upper face, the block having a cavity which is connected by a circuit to the suction device and which is in communication with the upper face.

Thus, the suction of particles from the shoe is more effective.

For example, the block is an integral part of the brake head.

For example, the return mechanism is a spring.

For example, the connecting ring comprises a flange which comes into contact solely with the base, and the return mechanism is the flange.

The invention will be better understood and its advantages will become more apparent upon reading the following detailed description of some embodiments represented by way of non-limiting examples. The description refers to the attached drawings, in which:

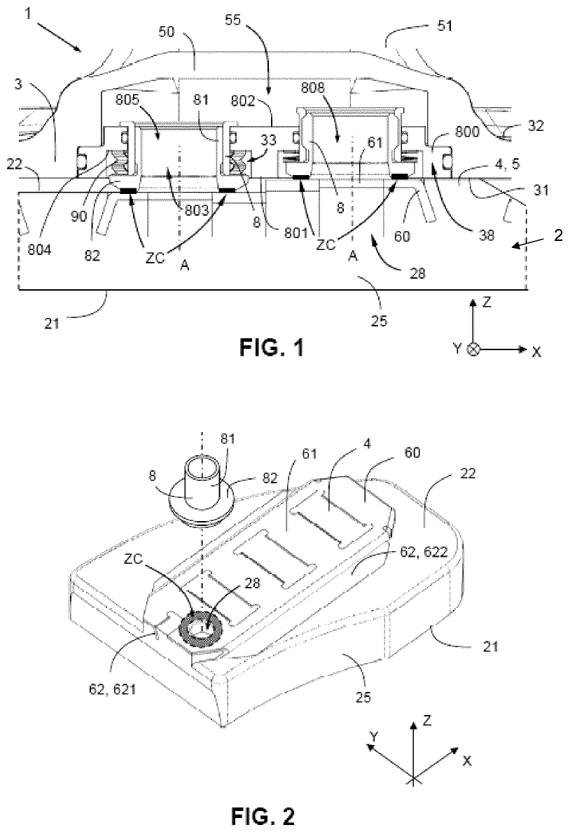

FIG. 1 is a section view of part of a friction assembly according to the invention.

FIG. 2 is a perspective view of the shoe and of a connecting ring of a friction assembly according to the invention.

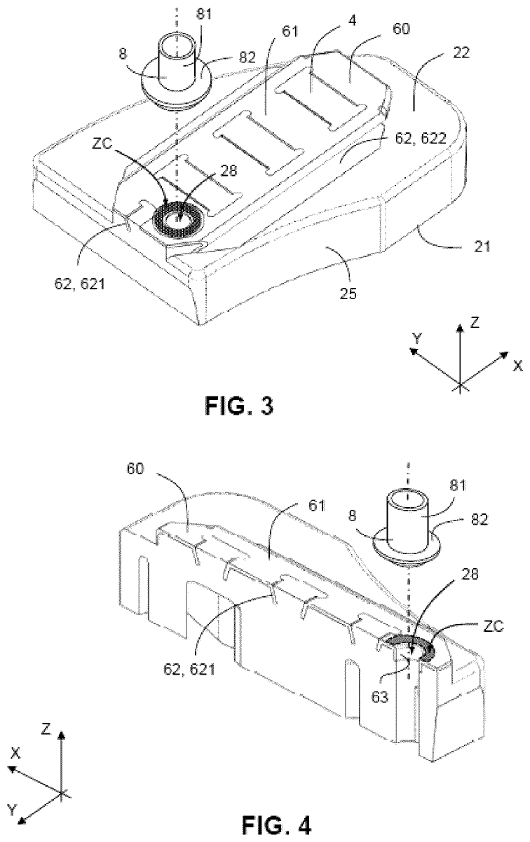

FIG. 3 is a perspective view of the shoe and of a connecting ring of a friction assembly according to a variant of the invention.

FIG. 4 is a perspective section view of the shoe and of a connecting ring of a friction assembly according to another variant of the invention.

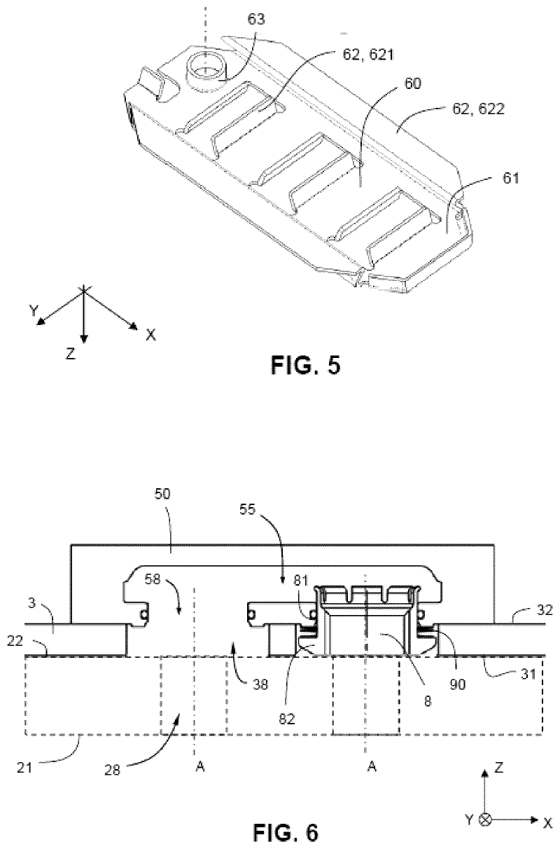

FIG. 5 is a perspective view from below of the shoe of the friction assembly of FIG. 4.

FIG. 6 is a section view of part of a friction assembly according to the invention, illustrating another embodiment of the brake head, the block, and the connecting rings.

FIG. 7, already described, is a bottom view of a friction assembly according to the prior art.

FIG. 8, already described, is a cross-section along line VIII-VIII of FIG. 7.

FIG. 9, already described, is a perspective view of a shoe according to the prior art, which illustrates the plate fixed to the friction material.

### DETAILED DESCRIPTION OF THE INVENTION

FIG. 1 illustrates a friction assembly 1 for a brake system for railway rolling stock. For example, these brakes are disc brakes. For example, these brakes are brakes on the running surface of the rolling stock wheel. The assembly extends longitudinally along a longitudinal axis X, and vertically along a vertical axis Z. The transverse axis Y forms a trigonometric frame of reference with axes X and Z. Friction assembly 1 is represented in cross-section in the vertical plane X, Z, meaning in the plane which passes through the central axes A of the secondary ducts 38. The Y axis is directed towards the back of the page. For the sake of clarity, only the portion of friction assembly 1 which carries rings 8 (see below) is shown. The adjectives “lower” and “upper” are used in reference to the upwardly oriented vertical axis Z.

Friction assembly 1 comprises on the one hand a brake head 3, and on the other hand at least one shoe 2 made of friction material. Brake head 3 has a lower face 31 and an upper face 32. Shoe 2 has a first face 21 which is the friction face, and a second face 22. In operation, shoe 2 is secured to brake head 3 by a fastening mechanism 4, 5. For example, this fastening mechanism comprises a receiving slide 5 which is formed in lower face 31, and a profile 4 which is formed on second face 22 and which is configured to engage with receiving slide 5. Thus, the securing of shoe 2 to brake head 3 is achieved by the insertion and translation of profile 4 in slide 5 along the longitudinal axis X. The fastening mechanism is then such that this securing is removable. Profile 4 can be seen in FIG. 2. Generally speaking, the securing of shoe 2 to brake head 3 is removable, which allows replacing shoe 2 once it is worn out.

Shoe 2 comprises at least one primary duct 28 which connects first face 21 and second face 22 in a fluidtight manner. In FIG. 1, shoe 2 comprises two primary ducts 28. Brake head 3 comprises at least one secondary duct 38 of central axis A which connects upper face 32 and lower face 31 in a fluidtight manner at the bottom of receiving slide 5. In FIG. 1, brake head 3 comprises two secondary ducts 38. Brake head 3 comprises at least one connecting ring 8 arranged in the at least one secondary duct 38 and establishing a connection with the at least one primary duct 28. In FIG. 1, brake head 3 comprises two connecting rings 8. When shoe 2 is secured to brake head 3, each primary duct 28 is aligned with a secondary duct 38, meaning that the central axis of each primary duct 28 is the central axis A of the secondary duct 38 with which it is aligned.

A connecting ring 8 comprises a tubular body 81 and a flange 82 at one end of body 81. Flange 82 extends radially outwards from body 81, and therefore has a diameter greater than the outside diameter of body 81. For example, the inside diameter of body 81 is greater than the diameter of a primary duct 28, in order to compensate for clearances between shoe 2 and brake head 3 along axis X. The distal end of body 81 is therefore located opposite flange 82.

Shoe 2 is secured to brake head 3 until shoe 2 is covering each of connecting rings 8. This situation is illustrated in FIG. 1, in the case where the brake shoe has two halves. FIG. 1 is a section view in plane X, Z of a portion of friction assembly 1. In the right part of FIG. 1, the right half of shoe 2 is pressed against brake head 3 such that second face 22 of this right half is in contact with lower face 31 of brake head 3. In the left part of FIG. 1, there is a clearance between the left half of shoe 2 and brake head 3 such that second face 22 of this left half is not in contact with lower face 31 of brake head 3. In all cases, return mechanism 90 (see below) presses connecting ring 8 against second face 22 of shoe 2, and the distal ends of connecting rings 8 are in cavity 55.

In the description below we use the plural for the elements “primary ducts 28”, “secondary ducts 38”, “connecting rings 8”, “holes 58”, “holes 808”, and the determiner “each”, to deal with cases of two or more of these elements. The description below is also valid in the case of a single primary duct 28, a single secondary duct 38, a single connecting ring 8, a single hole 58, and a single hole 808.

Friction assembly 1 further comprises a manifold block 50 which is secured to brake head 3 at upper face 32. For example, block 50 is a pneumatic manifold block. For example, block 50 is an integral part of brake head 3. “Is an integral part” is understood to mean that block 50 cannot be separated from brake head 3, except with tools. For example, block 50 is molded with brake head 3, or is welded to brake head 3. Block 50 covers upper face 32 of brake head 3 at the portion of upper face 32 which comprises the openings of secondary ducts 38. Block 50 comprises a cavity 55 which is connected to a circuit 51 which is connected to a suction device. Cavity 55 is in communication with upper face 32.

As illustrated in FIG. 1, rings 8 are mounted on a plate 800 which has as many holes 808 as there are rings 8. Plate 800 has a lower face 801 and an upper face 802, the axis of each hole 808 being perpendicular to these faces 801, 802. Each hole 808 connects lower face 801 and an upper face 802. When a ring 8 is mounted in a hole 808, the axis of ring 8 is coaxial with hole 808. Plate 800 is inserted and placed in a housing 33 of brake head 3 from below (via lower face 31 of brake head 3) so that lower face 801 is parallel and aligned with lower face 31, as illustrated in FIG. 1. Alternatively, lower face 801 is parallel to lower face 31 and slightly above it, meaning that lower face 801 is recessed relative to lower face 31. In both cases, when plate 800 is placed in housing 33, the periphery of upper face 802 of plate 800 bears against the bottom of housing 33 and the area of upper face 802 which is carrying rings 8 is open to cavity 55. For example, upper face 802 has a raised central part. Rings 8 are open to cavity 55, and the axis of each ring 8 is coaxial with the axis of a primary duct 28.

Each hole 808 comprises a lower portion 803 and an upper portion 805. Flange 82 of ring 8 is housed in lower portion 803, and body 81 of ring 8 passes through upper portion 805. The diameter of lower portion 803 is greater than the diameter of upper portion 805, such that there is a shoulder 804 where these portions meet. The diameter of flange 82 is equal to or slightly less than the diameter of lower portion 803. The diameter of upper portion 805 is equal to or slightly greater than the outside diameter of body 81, and less than the diameter of flange 82. Flange 82 therefore abuts against shoulder 804, either directly or indirectly, as explained below.

In this situation in which rings 8 are mounted on a plate 800, lower portion 803 of each hole 808 of plate 800 constitutes a secondary duct 38, and upper portion 803 of each hole 808 of plate 800 constitutes a hole 58 separating cavity 55 from brake head 3 (see below).

Alternatively, as shown in FIG. 6, rings 8 are mounted in secondary ducts 38 of brake head 3. For clarity, one of rings 8, which would be housed in left secondary duct 38, is removed. Flange 82 of ring 8 is housed in secondary duct 38. Cavity 55 is separated from brake head 3 by a wall which is in contact with upper face 32 of brake head 3 and which has holes 58 located opposite secondary ducts 38. Body 81 of ring 8 passes through these holes and is open to cavity 55. The diameter of flange 82 is equal to or slightly less than the diameter of secondary duct 38. The diameter of each of holes 58 is equal to or slightly greater than the outside diameter of body 81, and less than the diameter of flange 82. Thus, when ring 8 is inserted into secondary duct 38, flange 82 abuts against the edge of hole 58 which is located opposite secondary duct 38, either directly or indirectly, as explained below.

In all cases, flange 82 of ring 8 is located at lower face 31, and body 81 extends from flange 82 towards cavity 55 through brake head 3.

In the example shown in FIG. 1 and in the example shown in FIG. 6, block 50 is an integral part of brake head 3; a plate 800 carrying rings 8 therefore cannot be placed in housing 33 via upper face 32. Similarly, a ring 8 cannot be inserted into a secondary duct 38 via upper face 32. Each ring 8 can be inserted into a secondary duct 38, or plate 800 placed in housing 33, only via lower face 31, before securing brake shoe 2 to brake head 3.

As mentioned above, in the case where rings 8 are mounted on a plate 800 (FIG. 1), flange 82 therefore abuts against shoulder 804 in hole 808 of plate 800. In the case where rings 8 are mounted in secondary ducts 38 (FIG. 6), flange 82 abuts against the edge of hole 58. In both cases, flange 82 may be in abutment either directly or indirectly, as explained below.

In the case of indirect contact, a spring (for example a helical spring, a wave spring, or a compressed seal) is mounted on body 81 between flange 82 and shoulder 804 or the edge of hole 58. At rest, the spring is in contact with flange 82 and the shoulder or the edge of hole 58, and flange 82 protrudes from lower face 31 (for example at the bottom of slide 5 if slide 5 is present). When shoe 2 is secured to brake head 3 (for example by sliding profile 4 of shoe 2 in slide 5), second face 22 is in contact with lower face 31, flange 82 is pushed back into hole 808 or into secondary duct 38 and compresses the spring. This solution is shown in FIG. 1 and FIG. 6.

In the case of direct contact between flange 82 and the edge of hole 58 (FIG. 6) or between flange 82 and shoulder 804 in hole 808 of plate 800 (FIG. 1), flange 82 is shaped in such a manner that, when not deformed, it protrudes from lower face 31. When shoe 2 is secured to brake head 3, flange 82 is deformed between second face 22 and shoulder 804 or the edge of hole 58. This deformation is for example a compression of the material of the flange along axis A. Alternatively, flange 82 has a convex or concave shape at rest, and this deformation is a flattening of flange 82. In all cases of direct contact, the deformation of flange 82 also fulfills a sealing function between ring 8 and second face 22.

In both cases of contact (direct or indirect), flange 82 comes into contact only with base 61 of plate 60 and fits against the surface of base 61 so as to be held pressing against second face 22 of shoe 2. This retention is achieved either by deformation of flange 82 itself (flange 82 then constitutes return mechanism 90), or by compression of the spring (which then constitutes return mechanism 90). Return mechanism 90 allows pressing flange 82 against second face 22. Other return mechanisms 90 fulfilling the same function may be used.

Flange 82 blocks translational movement of ring 8 in secondary duct 38 along axis A in one direction, namely the upward direction in the figures showing ring 8 (upward movement of ring 8).

Shoe 2 comprises a friction material 25, and a plate 60 which has a base 61 and tabs 62 extending from base 61. For example, plate 60 is made of metal. Base 61 forms part of second face 22 of shoe 2. Tabs 62 are curved towards first face 21 (friction face). Thus, tabs 62 comprise first tabs 621 which penetrate friction material 25 so as to fasten friction material 25 to plate 60. FIG. 2 shows shoe 2 in the case where fastening mechanism 4, 5 comprises a slide 5 and a profile 4. In this case, base 61 forms part of opposite face 22 and of profile 4. Tabs 62 optionally comprise second tabs 622 which fit closely to the shape (for example convex) of profile 4 so as to mechanically hold friction material 25 against base 61.

When shoe 2 is secured to brake head 3 by sliding profile 4 in slide 5, flange 82 of each ring 8 is pressed against second face 22 of profile 4, as explained above. Flange 82 thus comes into contact with plate 60 at a contact zone ZC. In the general case where the lower end of ring 8 is not a flange but another shape, it is this lower end which comes into contact with plate 60 at a contact zone ZC. Contact zone ZC is circumferential so as to completely surround the axis of ring 8 at the surface (for example a plane) where this contact zone extends, in order to establish a seal. Contact zone ZC therefore completely surrounds the central axis A of secondary duct 38. For example, contact zone ZC is annular. Contact zone ZC always has a central hole which corresponds to the opening of primary duct 28 of shoe 2. Ring 8 is coaxial with primary duct 28.

Plate 60 is shaped such that each connecting ring 8 comes into contact only with base 61 and fits closely against the surface of base 61 at contact zone ZC. In the case where the end of connecting ring 8 is a flange 82, the portion of connecting ring 8 which forms contact zone ZC is the top of flange 82. Contact zone ZC is thus annular and flat or substantially flat, as can be seen in FIGS. 1 and 2. Base 61 is therefore flat or substantially flat and uniform at contact zone ZC. The close contact between ring 8 and base 61 at contact zone ZC minimizes leaks between ring 8 and shoe 2.

Comparing FIG. 9, which represents an example according to the prior art, and FIG. 2, a tab 62 has been removed and base 61 has been extended so that contact zone ZC is solely composed of base 61. Other modifications (configuration) of plate 60 are possible, provided that contact zone ZC is solely composed of base 61.

FIG. 3 shows a variant embodiment in which the surface of the base 61 has undergone surface treatment at contact zone ZC so that this surface fits even more closely against the surface of the at least one ring 8 than if there had not been any surface treatment. This surface treatment is for example polishing. For example, in the case where it is the top of flange 82 which is in contact with base 61, polishing of contact zone ZC, which is annular and flat, is carried out.

FIG. 4 shows an alternative embodiment in which plate 60 has a cylinder 63 which extends from base 61 along the wall of primary duct 28 over a given minimum height. Cylinder 63 fits closely against the wall of primary duct 28. Cylinder 63 is produced by any means. For example, cylinder 63 is a stamped part made by stamping plate 60. The fastening of plate 60 to friction material 25 is thus reinforced. Advantageously, plate 60 has as many cylinders 63 as primary ducts 28, each of primary ducts 28 thus having a cylinder 63 which extends along at least part of its wall.

FIG. 5 illustrates plate 60 in a perspective view from below. One can thus see cylinder 63 which extends along the vertical axis Z in the negative direction from base 61 so as to penetrate into primary duct 28.

1.-7. (canceled)

8. Friction assembly for a brake system for railway rolling stock, said friction assembly comprising:
a brake head comprising a lower face, an upper face, and at least one secondary duct of a central axis which connects said lower face and said upper face,
at least one shoe which has a first face comprising a friction face and a second face which is adapted to be fixed on said lower face by a fastening mechanism, and at least one primary duct which connects said first face and said second face, said shoe comprising a friction material and a plate which has a base which forms part of the second face,
said friction assembly further comprising at least one connecting ring which is arranged in said at least one secondary duct and which establishes a connection with said at least one primary duct when said at least one primary duct is aligned with said at least one secondary duct, and
a return mechanism which keeps said at least one connecting ring in contact with said second face at a circumferential contact zone,
wherein said plate is shaped so that said at least one connecting ring comes into contact only with said base of the plate and fits closely against said base at said contact zone.

9. Friction assembly according to claim 8, wherein said base is surface treated at said contact zone such that the base fits more closely against the at least one ring at said contact zone.

10. Friction assembly according to claim 8, wherein said plate has at least one cylinder which extends from said base along a wall of said at least one primary duct.

11. Friction assembly according to claim 8, further comprising a manifold block which is connected to a suction device and which is secured to said brake head at said upper face, said block having a cavity which is connected by a circuit to the suction device and which is in communication with said upper face.

12. Friction assembly according to claim 11, wherein said block is an integral part of said brake head.

13. Friction assembly according to claim 8, wherein said return mechanism is a spring.

14. Friction assembly according to claim 8, wherein each of said at least one connecting ring comprises a flange which comes into contact solely with said base, and said return mechanism is said flange.
